(19) United States
(12) Patent Application Publication
(10) Pub. No.: US 2026/0219424 A1
(43) Pub. Date: Jul. 30, 2026

(54) SPECTACLE LENS COMPRISING AN ANTI-REFLECTIVE COATING

(71) Applicant: Carl Zeiss Vision International GmbH, Aalen (DE)

(72) Inventors: Tiancheng Liang, Aalen (DE); Andreas Neuffer, Asperg (DE); Bernhard von Blanckenhagen, Aalen (DE)

(73) Assignee: Carl Zeiss Vision International GmbH, Aalen (DE)

(21) Appl. No.: 19/273,868

(22) Filed: Jul. 18, 2025

(30) Foreign Application Priority Data
Jan. 30, 2025 (EP) 25 155 077.8

(51) Int. Cl. G02B 1/116; G02B 1/16; G02C 7/02; G02C 7/10

(52) U.S. Cl. CPC G02B 1/116; G02B 1/16; G02C 7/024; G02C 7/107

(57) ABSTRACT

A spectacle lens has an anti-reflective coating as defined in ISO 13666:2019(E), entry 3.18.3. The anti-reflective coating contains a plurality of layers and has, in an interval of angles of incidence, a residual reflectance color in CIE 1976 L*a*b* color space. At an angle of incidence of 0°, positions of CIELAB a*,b* coordinates for the residual reflectance color lie in a rectangular region in an a*,b* plane, the rectangular region in the a*,b* plane being defined by 2≤a*≤9.2 and 7≤b*≤16.8, in an interval of angles of incidence of >0° and an angle of incidence of 75°, each position of CIELAB a*, b* coordinates in the a*,b* plane has a value D≥0, with D=b*+6.5·a*+6.5. The CIELAB a*,b* coordinates are determined with respect to a single surface of the spectacle lens containing the anti-reflective coating.

### CROSS REFERENCE TO RELATED APPLICATIONS

This application claims priority to European patent application EP 25 155 077.8 filed on Jan. 30, 2025, which is hereby incorporated by reference in its entirety.

### TECHNICAL FIELD

The present disclosure relates to a spectacle lens having a layer stack and a method for calculating, by a computer, data for such a spectacle lens.

### BACKGROUND

WO 2020/053140 A1 discloses an optical element comprising an interferometric reflection-reducing layer system on at least one surface of a substrate. The layer system comprises a stack of at least four successive layer packets. The layer system has a lightness L*, a chroma C*, and a hue angle h of a residual reflection color. An absolute value of a hue angle difference of the residual reflection color in an interval of angles of incidence ranging from 0° and 30° is smaller than an absolute value of a chroma difference in the range of angles of incidence.

Based on WO 2020/053140 A1 disclosing an interferometric reflection-reducing layer system providing to an optical element a color stable residual reflection color for an interval of angles of incidence ranging from 0° to 30°, the problem underlying the present disclosure is to increase the interval of angles of incidence.

### SUMMARY

The problem is solved by the spectacle lens a spectacle lens having a layer stack providing a color stable residual reflection color and a method for calculating, by a computer, data of such a spectacle lens.

The spectacle lens comprises an anti-reflective coating, the anti-reflective coating as defined in ISO 13666:2019(E), entry 3.18.3, the anti-reflective coating comprising a layer stack, the spectacle lens having, in an interval of angles of incidence, a residual reflectance color in CIE 1976 L*a*b* color space, the spectacle lens is characterized in that
at an angle of incidence of 0°, positions of CIELAB a*, b* coordinates for the residual reflectance color lie in a rectangular region in an a*,b* plane, the rectangular region in the a*,b* plane being defined by 2≤a*≤9.2 and 7≤b*≤16.8,
in an interval of angles of incidence limited by an angle of incidence of >0° and an angle of incidence of 75°, each position of CIELAB a*,b* coordinates for the residual reflectance color, in the a*,b* plane, has a value D≥0, with D=b*+6.5·a*+6.5,
the CIELAB a*,b* coordinates are determined with respect to a single surface of the spectacle lens comprising the anti-reflective coating.

A “spectacle lens” is as defined in ISO 13666:2019(E), entry 3.5.2, an ophthalmic lens (3.5.1) an ophthalmic lens worn in front of, but not in contact with, an eyeball. A “surface” of the spectacle lens is at least one of a front surface of the spectacle lens and a back surface of the spectacle lens, the front surface of the spectacle lens as defined in ISO 13666:2019(E), entry 3.2.13, the back surface of the spectacle lens as defined in ISO 13666:2019(E), entry 3.2.14.

An “anti-reflective coating” is as defined in ISO 13666:2019(E), entry 3.18.3, a coating on a surface of the spectacle lens (3.5.2) intended to reduce light (3.1.2) reflected from its surfaces. As in note 1 to entry 3.18.3 of ISO 13666:2019(E), the anti-reflective coating may, for example, be combined with a clean coating (3.18.4), a hydrophobic coating (3.18.5) or an anti-static coating (3.18.3). Typically, the anti-reflective coating is combined with the clean coating, preferable the clean coating having a water contact angle of greater than or equal to 100°. In case the anti-reflective coating is combined with the clean coating, typically the anti-reflective coating is closer to the surface of the spectacle lens than the clean coating.

Typically, the spectacle lens comprising the anti-reflective coating on a single surface thereof exhibits a luminous reflectance of ≤1.5, the luminous reflectance as defined in ISO 13666:2019(E), entry 3.17.16. In case the spectacle lens is based on an optical material other than glass, i.e., in case the spectacle lens is based on a thermosetting hard resin or a thermoplastic hard resin, the anti-reflective coating typically is combined with a hard coating, the optical material as defined in ISO 13666:2019(E), entry 3.3.1, the glass as defined in ISO 13666:2019(E), entry 3.3.2, the thermosetting hard resin as defined in ISO 13666:2019(E), entry 3.3.3, the thermoplastic hard resin as defined in ISO 13666:2019(E), entry 3.3.4, and the hard coating as defined in ISO 13666:2019(E), entry 3.18.2. In case the anti-reflective coating is combined with the hard coating, typically the hard coating is closer to the surface of the spectacle lens than the anti-reflective coating.

The anti-reflective coating comprises a layer stack, the layer stack comprises a plurality of layers. Typically, each layer of the plurality of layers has a uniform refractive index. Typically, adjacent layers in the layer stack have a different refractive index, each layer of the adjacent layers typically has a uniform refractive index.

An “angle of incidence interval” is limited by an angle of incidence θ₁ and an angle of incidence θ₂, whereby the angle of incidence θ₂ is larger than the angle of incidence θ₁. The angle of incidence θ₁ and the angle of incidence θ₂ limiting the angle of incidence interval shall be included in the angle of incidence interval.

An “angle of incidence” is an angle between a ray of light incident on the surface of the spectacle lens at a point of incidence and a line perpendicular to the surface at the point of incidence.

A residual reflectance is expressed as a value of CIELAB lightness L* in CIE 1976 L*a*b* color space. In particular the residual reflectance of the spectacle lens comprising the anti-reflective coating on a single surface of the spectacle lens is expressed as the value of CIELAB lightness L* in CIE 1976 L*a*b* color space. The CIELAB lightness L* is as defined in ISO/CIE 11664-4:2019(E), entry 5.1. Typically, the spectacle lens comprising the anti-reflective coating on a single surface of the spectacle lens has a value for the CIELAB lightness L* smaller than or equal to 15. Typically, the CIELAB lightness L* is in one of the following ranges: range of from L*=5 to L*=15, a range of from L*=7 to L*=13, a range of from L*=8 to L*=11.

The CIELAB lightness L* for the residual reflectance is calculated using data of a spectral reflectance of the spectacle lens comprising the anti-reflective coating on a single surface of the spectacle lens. For calculating the CIELAB lightness L* for the residual reflectance, CIE standard illuminant D65 and a 10° observer are selected.

The spectral reflectance of the spectacle lens comprising the anti-reflective coating on a single surface of the spectacle lens is defined analogously as in ISO 13666:2019(E), entry 3.17.15, as ratio of a spectral radiant or luminous flux reflected by the surface of the spectacle lens comprising the anti-reflective coating to an incident spectral radiant or luminous flux at any specified wavelength, λ, for a specified angle of incidence.

At the angle of incidence of 0°, the spectral reflectance of the spectacle lens comprising on a single surface thereof the anti-reflective coating, typically is measured with the Instrument F10-AR, Filmetrics, USA.

Alternatively, the spectral reflectance of the spectacle lens comprising the anti-reflective coating on a single surface of the spectacle lens is simulated as a function of wavelength, typically using the software Optilayer (OptiLayer, OptiLayer 64 for Windows, Version 14.57, OptiLayer GmbH, Germany). For the simulation, typically the refractive index of the optical material of the spectacle lens and the refractive incidences of the layers of the layer stack, a layer sequence of the layers in the layer stack as well as their respective layer thicknesses are taken into consideration. In case the spectacle lens comprises a hard coating and/or a primer hard coating, a respective layer thickness and a respective refractive index is also taken into consideration.

A “residual reflectance color” is expressed as positions of CIELAB a*,b* coordinates in CIE 1976 L*a*b* color space. In particular the residual reflectance color of the spectacle lens comprising the anti-reflective coating on a single surface of the spectacle lens is expressed as positions of CIELAB a*,b* coordinates in CIE 1976 L*a*b* color space. The “CIELAB a*,b* coordinates” are as defined in ISO/CIE 11664-4:2019(E), entry 5.1. The CIELAB a*,b* coordinates for the residual reflectance color are calculated using data of the spectral reflectance of the spectacle lens comprising the anti-reflective coating on a single surface of the spectacle lens. For calculating the CIELAB a*,b* coordinates, the CIE standard illuminant D65 and the 10° observer are selected.

At the angle of incidence of 0°, positions of CIELAB a*,b* coordinates for the residual reflectance color lie in a rectangular region in an a*,b* plane, the rectangular region in the a*,b* plane being defined by 2≤a*≤9.2 and 7≤b*≤16.8. In other words, at the angle of incidence of 0°, positions of CIELAB a*,b* coordinates for the residual reflectance color lie in the rectangular region in the a*,b* plane, whereby the rectangular region in the a*,b* plane is defined by four corner point positions of CIELAB a*,b* coordinates:
a first corner point position of CIELAB a*,b* coordinates with a*=2, b*=16.8,
a second corner point position of CIELAB a*,b* coordinates with a*=2, b*=7,
a third corner point position of CIELAB a*,b* coordinates with a*=9.2, b*=7,
a fourth corner point position of CIELAB a*,b* coordinates with a*=9.2, b*=16.8.

The positions of CIELAB a*,b* coordinates are given, at the angle of incidence of 0°, for the residual reflectance color of the spectacle lens comprising the anti-reflective coating on a single surface thereof.

When targeting a golden residual reflectance color for the spectacle lens comprising on a single surface thereof the anti-reflective coating, the target golden residual reflectance color has, with respect to CIE standard illuminant D65 and a 10° observer, a target value for the CIELAB lightness L* of 9, a target value for the CIELAB a* coordinate of 5.6 and a target value for the CIELAB b* coordinate of 11.9. Positions of CIELAB a*,b* coordinates that lie in the a*,b* plane, at the angle of incidence of 0°, in the rectangular region defined before, are assumed to be tolerable for providing the golden residual reflectance color.

For comparison, at the angle of incidence of 0°, FIG. 17 of WO 2020/053140 A1 discloses a CIELAB chroma C*_{ab} of 6.5, and FIG. 19 of WO 2020/53140 A1 discloses a CIELAB hue angle h_{ab} of 84°. Converted to CIELAB a*,b* coordinates result in a value for the CIELAB a* coordinate of a*=0.6 and a value for the CIELAB b* coordinate of b*=6.5, providing a light yellow residual reflectance color.

In the interval of angles of incidence limited by the angle of incidence of >0° and the angle of incidence of 75°, each position of CIELAB a*,b* coordinates for the residual reflectance color, in the a*,b* plane, has a value D≥0, with D=b*+6.5·a*+6.5. In other words, in the interval of angles of incidence limited by the angle of incidence of >0° and the angle of incidence of 75°, each position of CIELAB a*,b* coordinates for the residual reflectance color in the a*b* plane is i) on a straight line defined by b*=−6.5·a*−6.5 or ii) to the right of the straight line defined by b*=−6.5·a*−6.5, in case CIELAB a* coordinates are on an abscissa with positive CIELAB a* coordinates to the right and CIELAB b* coordinates are on an ordinate above.

Each position of CIELAB a*,b* coordinates is given, in the interval of angles of incidence limited by the angle of >0° and the angle of incidence of 75°, for the residual reflectance color of the spectacle lens comprising the anti-reflective coating on a single surface thereof.

Although the CIELAB a*,b* coordinates for the residual reflectance color are given with respect to the spectacle lens comprising the anti-reflective coating on a single surface of the spectacle lens, it shall be understood that the spectacle lens may comprise and typically comprises the anti-reflective coating on both surfaces of the spectacle lens.

Positioning CIELAB a*,b* coordinates in the interval of angles of incidence limited by the angle of incidence of >0° and the angle of incidence of 75° in the a*,b* plane such that the value D is greater than or equal to zero, with D=b*+6.5·a*+6.5 ensures that the golden residual reflectance color is maintained for angles of incidence not equal to 0°. Maintaining the golden reflectance color goes along with the fact that undesired changes in the residual reflectance color, for example an undesired greenish shimmer, are reduced and found to be acceptable. When looking at higher angles of incidence on the spectacle lens, which is usually the case in everyday life, any deviation from the expected residual reflectance color, in this case the golden residual reflectance color, may be perceived as unesthetic, in particular when the golden residual reflectance color is disturbed by a different residual reflectance color.

Compared to WO 2020/053140 A1, also aiming at color stable residual reflectance colors for anti-reflective coatings, the interval of angles of incidence for which a color stability is observed, is increased.

Typically, the spectacle lens comprising the anti-reflective coating, the anti-reflective coating comprising the layer stack, the spectacle lens having, in the interval of angles of incidence, the residual reflectance color in CIE 1976 L*a*b* color space, is characterized in that in the interval of angles of incidence limited by the angle of incidence of >0° and the angle of incidence of 75°, each position of CIELAB a*,b* coordinates for the residual reflectance color, in the a*,b* plane, has a value D1≤0, with D₁=b*+6.9·a*−80.

Positioning CIELAB a*,b* coordinates in the interval of angles of incidence limited by the angle of incidence of >0° and the angle of incidence of 75° in the a*,b* plane such that the value D₁ is smaller than or equal to zero, with D₁=b*+6.9·a*−80 ensures that the golden residual reflectance color is maintained for angles of incidence not equal to 0°. Further, maintaining the golden reflectance color goes along with the fact that undesired changes in the residual reflectance color, for example an undesired greenish shimmer, are reduced and found to be acceptable while the value D₁ smaller than or equal to zero additionally ensures that a rose residual reflectance color, a pink residual reflectance color or a reddish residual reflectance color is avoided. Also, the rose residual reflectance color, the pink residual reflectance color or the reddish residual reflectance color may be perceived as unesthetic when looking at higher angles of incidence on the spectacle lens.

Typically, the spectacle lens comprising the anti-reflective coating, the anti-reflective coating comprising the layer stack, the spectacle lens having, in the interval of angles of incidence, the residual reflectance color in CIE 1976 L*a*b* color space, is characterized in that in the interval of angles of incidence limited by the angle of incidence of >0° and the angle of incidence of 75°, a position of CIELAB a*,b* coordinates for the residual reflectance color, in the a*,b* plane, has a value D₂≥0, with D₂=b*+5.5·a*+13.75 and/or a position of CIELAB a*,b* coordinates for the residual reflectance color lie in the rectangular region in the a*,b* plane.

Positioning CIELAB a*,b* coordinates in the interval of angles of incidence limited by the angle of incidence of >0° and the angle of incidence of 75° in the a*,b* plane such that the value D₂ is greater than or equal to zero, with D₂=b*+5.5·a*+13.75 ensures that the golden residual reflectance color is maintained for angles of incidence not equal to 0°. Further, maintaining the golden reflectance color goes along with the fact that undesired changes in the residual reflectance color, for example an undesired greenish shimmer, are further reduced or completely avoided. This is especially of importance in case variations of layer thicknesses in the layer stack during the manufacturing process may occur.

Typically, the spectacle lens comprising the anti-reflective coating, the anti-reflective coating comprising the layer stack, the spectacle lens having, in an interval of angles of incidence, the residual reflectance color in CIE 1976 L*a*b* color space, is characterized in that in the layer stack a ratio of a sum over layer thicknesses of layers each having a refractive index n>2.1 at 500 nm to a sum over layer thicknesses of layers each having a refractive index n<1.6 at 500 nm is in one range selected from
a ratio of from 0.05 to 0.35
a ratio of from 0.07 to 0.28
a ratio of from 0.09 to 0.20
a ratio of from 0.10 to 0.18.

A layer having the refractive index n>2.1 at 500 nm typically comprises one of the following materials: TiO₂, Ta₂O₅, Nb₂O₅.

A layer having the refractive index n<1.6 at 500 nm typically comprises one of the following materials: SiO₂, mixtures of SiO₂ and Al₂O₃.

Having in the layer stack the ratio of the sum over layer thicknesses of layers each having the refractive index n>2.1 at 500 nm to the sum over layer thicknesses of layers each having the refractive index n<1.6 at 500 nm in one of the before mentioned ranges supports that a different residual reflectance color does not disturb the golden residual reflectance color of the spectacle lens comprising the anti-reflective coating. An additional benefit of the ratio is that due to a low amount of material having the refractive index n>2.1 at 500 nm in the layer stack, a visibility of scratches that may occur during usage time of the spectacle lens comprising the anti-reflective coating is reduced.

Typically, the spectacle lens comprising the anti-reflective coating, the anti-reflective coating comprising the layer stack, the spectacle lens having, in an interval of angles of incidence, the residual reflectance color in CIE 1976 L*a*b* color space, is characterized in that in the layer stack the ratio of the sum over layer thicknesses of layers each having the refractive index n>2.1 at 500 nm to the sum over layer thicknesses of layers each having the refractive index n<1.6 at 500 nm is in one range selected from
a ratio of from 0.15 to 0.41
a ratio of from 0.20 to 0.41
a ratio of from 0.22 to 0.41
a ratio of from 0.28 to 0.41,
   thereby not considering a maximum layer thickness of a layer having the refractive index n<1.6 at 500 nm.

As mentioned before, in the layer stack the ratio of the sum over layer thicknesses of layers each having the refractive index n>2.1 at 500 nm to the sum over layer thicknesses of layers each having the refractive index n<1.6 at 500 nm in one of the before mentioned range without considering the maximum layer thickness of the layer having the refractive index n<1.6 at 500 nm supports that the different residual reflectance color does not disturb the golden residual reflectance color of the spectacle lens comprising the anti-reflective coating. Again, the additional benefit of the ratio is that due to the low amount of material having the refractive index n>2.1 at 500 nm in the layer stack, the visibility of scratches that may occur during usage time of the spectacle lens comprising the anti-reflective coating is reduced.

Typically, the spectacle lens comprising the anti-reflective coating, the anti-reflective coating comprising the layer stack, the spectacle lens having, in an interval of angles of incidence, the residual reflectance color in CIE 1976 L*a*b* color space, is characterized in that in the layer stack a layer thickness of at least one layer having a refractive index n of 1.8≤n≤2.2 at 500 nm equals a layer thickness of at least one layer comprising a transparent conductive oxide.

A layer having the refractive index n of 1.8≤n≤2.2 at 500 nm typically comprises ZrO₂.

A layer comprising the transparent conductive oxide typically comprises indium tin oxide (ITO).

Typically without affecting the golden residual reflectance color, incorporating the layer stack at least one layer comprising the transparent conductive oxide renders electric anti-static properties to the spectacle lens comprising the anti-reflective coating. When the spectacle lens comprising the anti-reflective coating is for example rubbed with a piece of cotton cloth when the spectacle lens wearer cleans the spectacle lens, the build-up of electric static charges on the spectacle lens comprising the anti-reflective coating is prevented. This avoids the attraction and adherence of dust particles on the surface of the spectacle lens comprising the anti-reflective coating. Determining the layer thickness of the at least one layer comprising the transparent conductive oxide such that it equals the layer thickness of at least one layer having the refractive index n of 1.8≤n≤2.2 at 500 nm allows maintaining the golden residual reflectance color without a need to readjust layer thicknesses of other layers in the layer stack.

The data comprising at least one kind of the following kinds of data:
i) data of the spectacle lens described before, the data of the spectacle lens being configured for the purpose of a use for a manufacture of the spectacle lens described before,
ii) data containing computer-readable instructions for controlling one manufacturing machine or more manufacturing machines to manufacture the spectacle lens described before.

Alternatively or additionally, the data set may comprise data of the spectacle lens described before, the data of the spectacle lens being configured to be fed to one manufacturing machine or more manufacturing machines for manufacturing the spectacle lens described before.

The data set may be stored on a computer-readable storage medium or carried by a data carrier signal. The computer-readable medium may be a non-transitory tangible computer-readable storage medium.

The method configured for calculating, by a computer, data of a spectacle lens, the data of the spectacle lens comprising data of an anti-reflective coating, the data of the anti-reflective coating comprising data of a layer stack, the data of the spectacle lens comprising the data of the anti-reflective coating being configured for the purpose of a use for a manufacture of the spectacle lens comprising the anti-reflective coating, the method comprises the step of:
determining in the data of the layer stack a layer thickness of each layer of the layer stack such that a calculation of a residual reflectance color in CIE 1976 L*a*b* for the data of the spectacle lens comprising the data of the layer stack meets a predefined residual reflectance color in CIE 1976 L*a*b* color space at predefined angles of incidence,
   the method is characterized in that
   at a predefined angle of incidence of 0°, positions of CIELAB a*,b* coordinates for the predefined residual reflectance color lie in a rectangular region in an a*,b* plane, the rectangular region in the a*,b* plane being defined by 2≤a*≤9.2 and 7≤b*≤16.8,
   at each predefined angle of incidence lying in an interval of angles of incidence limited by a predefined angle of incidence of greater than 0° and a predefined angle of incidence of 75°, each position of CIELAB a*, b* coordinates for the predefined residual reflectance color, in the a*,b* plane, has a value D≥0, with D=b*+6.5·a*+6.5.

Typically, in the data of the layer stack, the layer thickness of each layer is determined for a single layer stack. Typically, in the data of the layer stack, the layers of the layer stack are predefined with respect to their respective refractive index. Typically, in the data of the layer stack, each layer of the layer stack has a uniform refractive index. Further, in the data of the layer stack, typically the layer sequence of the layer stack is predefined.

For calculating the residual reflectance color in CIE 1976 L*a*b* color space for the data of the spectacle lens comprising the data of the anti-reflective coating, i.e., for calculating positions of CIELAB a*,b* coordinates at predefined angles of incidence, typically the software Optilayer (OptiLayer, OptiLayer 64 for Windows, Version 14.57, OptiLayer GmbH, Germany) is used. For calculating the position of CIELAB a*,b* coordinates at predefined angles of incidence, data of the spectral reflectance of the data of the spectacle lens comprising the data of the anti-reflective coating is used, the data of the spectral reflectance at predefined angles of incidence being calculated using typically the software Optilayer (OptiLayer, OptiLayer 64 for Windows, Version 14.57, OptiLayer GmbH, Germany).

Typically, a use of the data of the spectacle lens comprising the data of the anti-reflective coating for purposes other than the manufacture of the spectacle lens comprising the anti-reflective coating is excluded.

In particular, the method is configured for calculating, by the computer, a design of the spectacle lens, the design of the spectacle lens comprising a design of the anti-reflective coating, the design of the anti-reflective coating comprising a design of a layer stack, the design of the spectacle lens comprising the design of the anti-reflective coating being configured for the purpose of the use for the manufacture of the spectacle lens comprising the anti-reflective coating, the method comprises the step of:
determining in the design of the layer stack a layer thickness of each layer of the layer stack such that a calculation of a residual reflectance color in CIE 1976 L*a*b* for the design of the spectacle lens comprising the design of the layer stack meets a predefined residual reflectance color in CIE 1976 L*a*b* color space at predefined angles of incidence,
   the method is characterized in that
   at a predefined angle of incidence of 0°, positions of CIELAB a*,b* coordinates for the predefined residual reflectance color lie in a rectangular region in an a*,b* plane, the rectangular region in the a*,b* plane being defined by 2≤a*≤9.2 and 7≤b*≤16.8,
   at each predefined angle of incidence lying in an interval of angles of incidence limited by a predefined angle of incidence of >0° and a predefined angle of incidence of 75°, each position of CIELAB a*, b* coordinates for the predefined residual reflectance color, in the a*,b* plane, has a value D≥0, with D=b*+6.5·a*+6.5.

Typically, the design of the spectacle lens is design data of the spectacle lens, the design of the anti-reflective coating is design data of the anti-reflective coating, the design of the layer stack is design data of the layer stack.

Typically, in the design of the layer stack, the layer thickness of each layer is determined for a single layer stack.

For calculating the residual reflectance color in CIE 1976 L*a*b* color space for the design of the spectacle lens comprising the design of the anti-reflective coating, i.e., for calculating positions of CIELAB a*,b* coordinates at predefined angles of incidence, typically the software Optilayer (OptiLayer, OptiLayer 64 for Windows, Version 14.57, OptiLayer GmbH, Germany) is used. For calculating the position of CIELAB a*,b* coordinates at predefined angles of incidence, data of the spectral reflectance of the design of the spectacle lens comprising the design of the anti-reflective coating is used, the data of the spectral reflectance at predefined angles of incidence being calculated using typically the software Optilayer (OptiLayer, OptiLayer 64 for Windows, Version 14.57, OptiLayer GmbH, Germany).

Typically, a use of the design of the spectacle lens comprising the design of the anti-reflective coating for purposes other than the manufacture of the spectacle lens comprising the anti-reflective coating is excluded.

In other words, the method is configured for calculating, by a computer, data of the anti-reflective coating, the data of the anti-reflective coating comprising data of the layer stack, the data of the anti-reflective coating together with data of the spectacle lens being configured for the purpose of the use for the manufacture of the spectacle lens comprising the anti-reflective coating, the method comprises the step of:
determining in the data of the layer stack, a layer thickness of each layer of the layer stack such that a calculation of a residual reflectance color in CIE 1976 L*a*b* for the data of the layer stack together with the data of the spectacle lens meets a predefined residual reflectance color in CIE 1976 L*a*b* color space at predefined angles of incidence,
   the method is characterized in that
   at a predefined angle of incidence of 0°, positions of CIELAB a*,b* coordinates for the predefined residual reflectance color lie in a rectangular region in an a*,b* plane, the rectangular region in the a*,b* plane being defined by 2≤a*≤9.2 and 7≤b*≤16.8,
   at each predefined angle of incidence lying in an interval of angles of incidence limited by a predefined angle of incidence of >0° and a predefined angle of incidence of 75°, each position of CIELAB a*, b* coordinates for the predefined residual reflectance color, in the a*,b* plane, has a value D≥0, with D=b*+6.5·a*+6.5.

Typically, the data of the anti-reflective coating comprises data of a single layer stack. Thus, in the data of the layer stack, typically the layer thickness of each layer is determined for the single layer stack.

Typically, in the data of the layer stack, the layers of the layer stack are predefined with respect to their respective refractive index. Typically, in the data of the layer stack, each layer of the layer stack has a uniform refractive index. Further, in the data of the layer stack, typically the layer sequence of the layer stack is predefined.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in that
the data of the anti-reflective coating is in form of an output file and the output file is configured for a data processing system operating a manufacturing unit for coating a surface of the spectacle lens.

Typically, the output file is a list of layer thicknesses of each layer of the layer stack. The list is transferred as input to the data processing system operating the manufacturing unit. The manufacturing typically is a vacuum coating system.

When defining the predefined residual reflectance color as described before, reference is made to the before given explanation with respect to the spectacle lens. Defining the predefined residual reflectance color as described before ensures that the golden residual reflectance color is maintained for angles of incidence not equal to 0°, thereby reducing the greenish shimmer.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in that
at each predefined angle of incidence lying in the interval of angles of incidence limited by the predefined angle of incidence of >0° and the predefined angle of incidence of 75°, each position of CIELAB a*,b* coordinates for the predefined residual reflectance color, in the a*,b* plane, has a value D₁≤0, with D₁=b*+6.9·a*−80.

When defining the predefined residual reflectance color as described before, reference is made to the before given explanation with respect to the spectacle lens. Defining the predefined residual reflectance color as described before ensures that the golden residual reflectance color is maintained for angles of incidence not equal to 0°, thereby reducing the greenish shimmer and avoiding the rose residual reflectance color, the pink residual reflectance color or the reddish residual reflectance color.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in that
at each predefined angle of incidence lying in the interval of angles of incidence limited by the predefined angle of incidence of >0° and the predefined angle of incidence of 75°, a position of CIELAB a*,b* coordinates for the predefined residual reflectance color, in the a*,b* plane, has a value D₂≥0, with D₂=b*+5.5·a*+13.75 and/or a position of CIELAB a*,b* coordinates for the predefined residual reflectance color lie in the rectangular region in the a*,b* plane.

When defining the predefined residual reflectance color as described before, reference is made to the before given explanation with respect to the spectacle lens. Defining the predefined residual reflectance color as described before further reduces the greenish shimmer which is undesired for the golden residual reflectance color.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in the step of:
determining the layer stack such that a ratio of a sum over layer thicknesses of layers each having a refractive index n>2.1 at 500 nm to a sum over layer thicknesses of layers each having a refractive index n<1.6 at 500 nm is in one range selected from
   a ratio of from 0.05 to 0.35
   a ratio of from 0.07 to 0.28
   a ratio of from 0.09 to 0.20
   a ratio of from 0.10 to 0.18.

When determining the ratio as described before, reference is made to the explanation given before for the respective ratio with respect to the spectacle lens.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in the step of
determining the layer stack such that a ratio of a sum over layer thicknesses of layers each having a refractive index n>2.1 at 500 nm to a sum over layer thicknesses of layers each having a refractive index n<1.6 at 500 nm is in one range selected from
   a ratio of from 0.15 to 0.41
   a ratio of from 0.20 to 0.41
   a ratio of from 0.22 to 0.41
   a ratio of from 0.28 to 0.41,
      thereby not considering a maximum layer thickness of a layer having the refractive index n<1.6 at 500 nm.

When determining the ratio as described before, reference is made to the explanation given before for the respective ratio with respect to the spectacle lens.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, is characterized in the step of:
determining the layer stack such that a layer thickness of at least one layer having a refractive index n of 1.8≤n≤2.2 at 500 nm equals a layer thickness of at least one layer comprising a transparent conductive oxide.

When incorporating at least one layer comprising a transparent conductive oxide in the layer stack as described before, reference is made to the respective explanation given before with respect to the spectacle lens.

Typically, the method configured for calculating, by the computer, data of the spectacle lens, the data of the spectacle lens comprising data of the anti-reflective coating, the data of the anti-reflective coating comprising data of the layer stack, the data of the spectacle lens comprising the data of the anti-reflective coating being configured for the purpose of the use for the manufacture of the spectacle lens comprising the anti-reflective coating, further comprises the step of manufacturing the spectacle lens comprising the anti-reflective coating based on the data of the spectacle lens comprising the data of the anti-reflective coating.

Typically, the anti-reflective coating is applied to the surface of the spectacle lens by physical vapour deposition.

The computer program comprises instructions which, when the program is executed by a computer, cause the computer to carry out the method described before.

The computer program may be stored on a non-transitory tangible computer-readable storage medium, the computer program comprising instructions which, when the program is executed by a computer, cause the computer to carry out the method described before.

The computer is configured to perform the method described before.

A data processing system comprising a processor and a storage medium coupled to the processor, wherein the processor is adapted to perform the method described before based on a computer program stored on the storage medium.

A computer-readable storage medium has stored thereon the computer program described before.

The computer-readable storage medium may be a non-transitory tangible computer-readable storage medium.

A data carrier signal carries the computer program described before.

### BRIEF DESCRIPTION OF THE DRAWINGS

The disclosure will now be described with reference to the drawings wherein:

FIG. 1 shows the CIELAB a*, b* coordinates for the spectacle lens of comparative example 1;

FIG. 2 shows the CIELAB a*, b* coordinates for the spectacle lens of example 1; and

FIG. 3 shows the CIELAB a*, b* coordinates for the spectacle lens of example 2.

### DESCRIPTION OF EXEMPLARY EMBODIMENTS

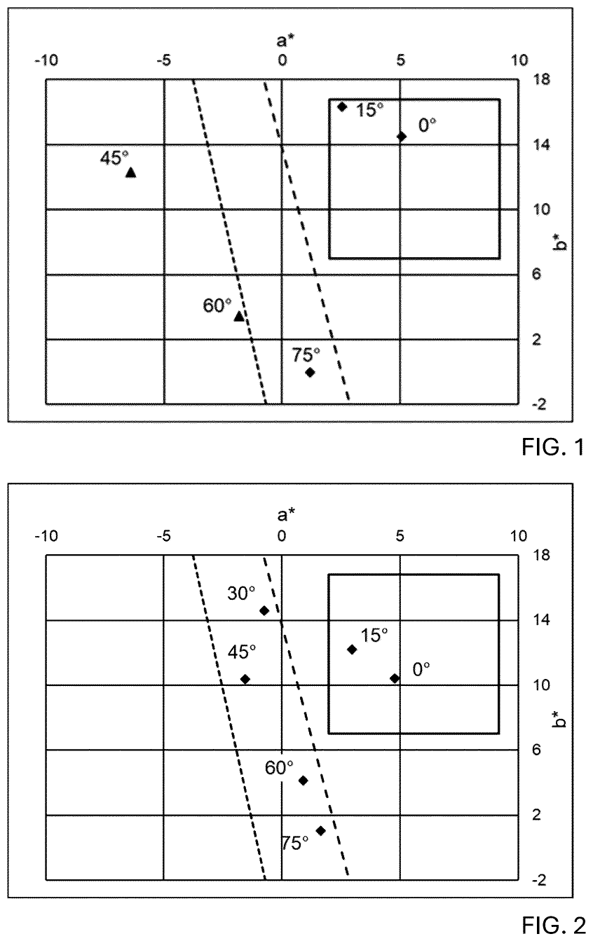

FIG. 1 shows CIELAB a*, b* coordinates for the spectacle lens of comparative example 1. In FIG. 1 at angles of incidence of 45° and 60°, positions CIELAB a*, b* coordinates are to the left of the short-broken line, i.e., D≤0, with D=b*+6.5·a*+6.5. At angles of incidence of 0° and 15°, positions CIELAB a*, b* coordinates lie in the rectangular region in the a*,b* plane, the rectangular region in the a*,b* plane defined by 2≤a*≤9.2 and 7≤b*≤16.8.

FIG. 2 shows CIELAB a*, b* coordinates for the spectacle lens of example 1. In FIG. 2 at angles of incidence of 0°, 15°, 30°, 45°, 60°, 75°, positions CIELAB a*, b* coordinates are to the right of the short-broken line, i.e., D≥0, with D=b*+6.5·a*+6.5. At angles of incidence of 0° and 15°, positions CIELAB a*, b* coordinates additionally lie in the rectangular region in the a*,b* plane, the rectangular region in the a*,b* plane defined by 2≤a*≤9.2 and 7≤b*≤16.8.

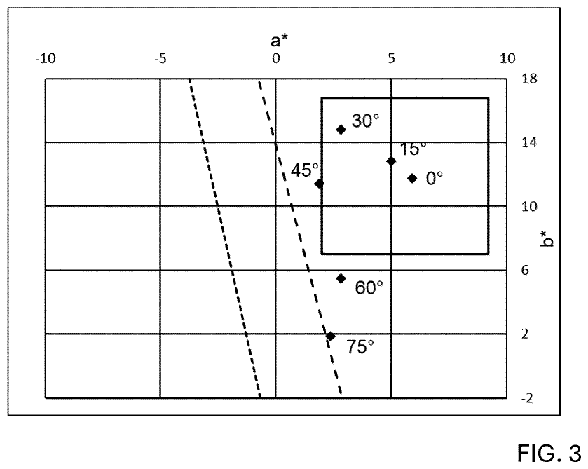

FIG. 3 shows CIELAB a*, b* coordinates for the spectacle lens of example 2. In FIG. 3 at angles of incidence of 0°, 15°, 30°, 45°, 60°, 75°, positions CIELAB a*, b* coordinates are to the right of the long-broken line, i.e., D₂≥0, with D₂=b*+5.5·a*+13.75. At angles of incidence of 0°, 15°, and 30° positions CIELAB a*, b* coordinates additionally lie in the rectangular region in the a*,b* plane, the rectangular region in the a*,b* plane defined by 2≤a*≤9.2 and 7≤b*≤16.8.

### I Simulation of the Anti-Reflective Coating for the Spectacle Lens

A layer sequence of the layers within the layer stack was selected. This layer sequence is known to deliver satisfactory mechanical properties to be used in an anti-reflective coating for spectacle lenses.

TABLE 1

| | Layer material |
|---|---|
| Layer sequence | Hard coating |
| L1 | ZrO₂ |
| L2 | SiO₂ |
| L3 | TiO₂ |
| L4 | SiO₂ |
| L5 | TiO₂ |
| L6 | SiO₂ |
| L7 | ITO |
| L8 | TiO₂ |
| L9 | SiO₂ |
| L10 | Clean coating |

### Comparative Example 1

Starting from the layer sequence in the Table 1 above the thicknesses for the layers L1 to L9 have been determined in a way that the spectral reflectance at an angle of incidence of 0° is, in CIE 1976 L*a*b* color space, in a rectangular region in an a*,b* plane defined by 2≤a*≤9.2 and 7≤b*≤16.8. This was done using the software Optilayer (OptiLayer, OptiLayer 64 for Windows, Version 14.57, OptiLayer GmbH, Germany). The layer thickness of L10 was kept constant at 5 nm. When giving the software the target value range for the residual reflectance color at 0° angle of incidence, the optimization methods provided by the software resulted in a set of layer thicknesses L1 to L9. Using these thicknesses the reflected color under oblique angles of incidence was calculated using the software. This was done for angles of incidence (aoi) between aoi=15° to aoi=75°. The values for the layer thickness set L1 to L9 of comparative example 1 are given in Table 2. As can be seen in FIG. 1, the positions of the CIELAB a*,b* coordinates in the a*,b* plane at angles of incidence aoi=450 and aoi=600 are on the left side of the straight line defined by the equation b*+6.5·a*+6.5=0, this means that the value of the function D=b*+6.5·a*+6.5 is smaller than 0.

As a result of positions of the CIELAB a*,b* coordinates in the a*,b* plane being on the left side of the straight line, the spectacle lenses comprising the layer stack will show a greenish shimmer at these angles of incidence.

### Example 1

The inventors found out that by a simple modification of the layer sequence of comparative example 1 the CIELAB a*,b* coordinates of a modified layer sequence fulfil the condition D>0 (D=b*+6.5·a*+6.5) meaning that the CIELAB coordinates a*,b* of the residual reflectance color now lie on the right side of the straight line defined by b*+6.5·a*+6.5=0. As a result of this no greenish shimmer is observed under oblique angles of incidence. Surprisingly, this advantageous result was obtained by a modification of the layer thickness of one layer alone, by changing the layer thickness of L1 from 6 nm to 3 nm.

### Comparative Example 2 to Comparative Example 4

The layer thicknesses of comparative example 2, comparative example 3, comparative example 4 have been obtained in the same approach as for comparative example 1.

### Example 2 to Example 17

Based on the finding of example 1, the layer thickness of L1 was chosen to be 3 nm for the examples 2 to 17. The layer thickness L10 was kept constant as well. The same approach as for comparative example 1 was used to find the sets of layer thicknesses. A selection of the results obtained by computer optimization resulted in the examples 2 to 17, all fulfil the condition D>0 (D=b*+6.5·a*+6.5) meaning that the CIELAB coordinates a*,b* of the residual reflectance color now lie on the right side of the straight line defined by b*+6.5·a*+6.5=0, as well as in the rectangular region defined before at aoi=0°.

In the following Tables 2 to 6 the resulting layer thicknesses are shown. In Table 2 and Table 3 the layer thicknesses for spectacle lenses based on an optical material with a refractive index of 1.5 and a hard coating with refractive index 1.48 are given. In Table 4, Table 5, and Table 6 the results for the spectacle lenses based on an optical material with a refractive index of with a refractive index of 1.6 and a hard coating with refractive index 1.58 are given.

TABLE 2

| | Spectacle lens according to example, | | | | |
|---|---|---|---|---|---|
| | comparative example, all values in nm | | | | |
| | comparative | | comparative | | |
| Layer | example 1 | example 1 | example 2 | example 2 | example 3 |
| ZrO₂ | 6.0 | 3.0 | 3.0 | 3.0 | 3.0 |
| SiO₂ | 219.2 | 219.2 | 230.2 | 219.7 | 226.6 |
| TiO₂ | 8.4 | 8.4 | 15.0 | 7.8 | 11.0 |
| SiO₂ | 43.5 | 43.5 | 30.3 | 45.1 | 43.9 |
| TiO₂ | 12.5 | 12.5 | 97.0 | 18.9 | 28.7 |
| SiO₂ | 32.0 | 32.0 | 7.4 | 30.7 | 24.6 |
| ITO | 3.0 | 3.0 | 3.0 | 3.0 | 3.0 |
| TiO₂ | 16.9 | 16.9 | 5.1 | 18.8 | 26.0 |
| SiO₂ | 93.1 | 93.1 | 61.9 | 84.3 | 80.4 |
| Clean coating | 5.0 | 5.0 | 5.0 | 5.0 | 5.0 |
| Layer stack thickness | 439.5 | 436.5 | 457.9 | 436.3 | 452.3 |
| ΣTiO₂ layer thicknesses | 37.8 | 37.8 | 117.1 | 45.5 | 65.7 |
| ΣSiO₂ layer thicknesses | 387.8 | 387.8 | 329.8 | 379.8 | 375.6 |
| ΣSiO₂ layer thickness | 168.6 | 168.6 | 99.6 | 160.0 | 149.0 |
| w/o 1. SiO₂ | | | | | |
| Ratio ΣTiO₂/ΣSiO2 | 0.22 | 0.22 | 1.18 | 0.28 | 0.44 |
| w/o 1. SiO₂ | | | | | |
| Ratio ΣTiO₂/ΣSiO₂ | 0.10 | 0.10 | 0.36 | 0.12 | 0.17 |

TABLE 3

| | Spectacle lens according to example, all values in nm | | | |
|---|---|---|---|---|
| Layer | example 4 | example 5 | example 6 | example 7 |
| ZrO₂ | 3.0 | 3.0 | 3.0 | 3.0 |
| SiO₂ | 209.9 | 203.8 | 214.1 | 219.5 |
| TiO₂ | 9.2 | 9.0 | 9.1 | 6.6 |
| SiO₂ | 47.7 | 47.9 | 44.4 | 46.5 |
| TiO₂ | 27.8 | 28.1 | 21.4 | 16.4 |
| SiO₂ | 27.2 | 27.7 | 27.2 | 34.1 |
| ITO | 3.0 | 3.0 | 3.0 | 3.0 |
| TiO₂ | 27.1 | 28.1 | 20.3 | 17.2 |
| SiO₂ | 81.8 | 80.8 | 83.2 | 85.3 |
| Clean coating | 5.0 | 5.0 | 5.0 | 5.0 |
| Layer stack thickness | 441.8 | 436.3 | 430.8 | 436.6 |
| ΣTiO₂ layer thicknesses | 64.1 | 65.1 | 50.9 | 40.2 |
| ΣSiO₂ layer thicknesses | 366.7 | 360.2 | 369.0 | 385.4 |
| ΣSiO₂ layer thickness | 156.7 | 156.4 | 154.9 | 165.9 |
| w/o 1. SiO₂ | | | | |
| Ratio ΣTiO₂/ΣSiO2 | 0.41 | 0.42 | 0.33 | 0.24 |
| w/o 1. SiO₂ | | | | |
| Ratio ΣTiO₂/ΣSiO₂ | 0.17 | 0.18 | 0.14 | 0.10 |

TABLE 4
Spectacle lens according to example, comparative example, all values in nm

| | comparative | comparative | | | |
|---|---|---|---|---|---|
| Layer | example 3 | example 4 | example 8 | example 9 | example 10 |
| ZrO₂ | 6.0 | 3.0 | 3.0 | 3.0 | 3.0 |
| SiO₂ | 204.1 | 204.1 | 170.6 | 188.0 | 202.7 |
| TiO₂ | 12.6 | 12.6 | 3.5 | 10.5 | 12.5 |
| SiO₂ | 39.7 | 39.7 | 34.6 | 36.5 | 41.8 |
| TiO₂ | 17.3 | 17.3 | 10.7 | 25.0 | 15.8 |
| SiO₂ | 27.7 | 27.7 | 27.6 | 22.7 | 12.6 |
| ITO | 3.0 | 3.0 | 3.0 | 3.0 | 3.0 |
| TiO₂ | 14.3 | 14.3 | 7.8 | 22.0 | 9.4 |
| SiO₂ | 91.0 | 91.0 | 81.4 | 79.8 | 85.2 |
| Clean coating | 5.0 | 5.0 | 5.0 | 5.0 | 5.0 |
| Layer stack thickness | 420.7 | 417.7 | 347.2 | 395.4 | 390.9 |
| ΣTiO₂ layer thicknesses | 44.2 | 44.2 | 21.9 | 57.5 | 37.6 |
| ΣSiO₂ layer thicknesses | 362.6 | 362.6 | 314.2 | 326.9 | 342.3 |
| ΣSiO₂ layer thickness | 158.4 | 158.4 | 143.6 | 139.0 | 139.6 |
| w/o 1. SiO₂ | | | | | |
| Ratio ΣTiO₂/ΣSiO2 | 0.28 | 0.28 | 0.15 | 0.41 | 0.27 |
| w/o 1. SiO₂ | | | | | |
| Ratio ΣTiO₂/ΣSiO₂ | 0.12 | 0.12 | 0.07 | 0.18 | 0.11 |

TABLE 5
Spectacle lens according to example, all values in nm

| Layer | example 11 | example 12 | example 13 | example 14 | example 15 |
|---|---|---|---|---|---|
| ZrO₂ | 3.0 | 3.0 | 3.0 | 3.0 | 3.0 |
| SiO₂ | 205.0 | 196.4 | 205.0 | 209.1 | 210.3 |
| TiO₂ | 12.6 | 10.5 | 12.6 | 13.7 | 11.8 |
| SiO₂ | 40.7 | 37.0 | 40.7 | 41.0 | 40.7 |
| TiO₂ | 14.4 | 25.0 | 14.4 | 10.1 | 10.2 |
| SiO₂ | 13.5 | 22.7 | 13.5 | 9.5 | 13.6 |
| ITO | 3.0 | 3.0 | 3.0 | 3.0 | 3.0 |
| TiO₂ | 10.4 | 22.0 | 10.4 | 12.3 | 12.3 |
| SiO₂ | 85.2 | 79.8 | 83.6 | 88.5 | 89.6 |
| Clean coating | 5.0 | 5.0 | 5.0 | 5.0 | 5.0 |
| Layer stack thickness | 392.9 | 404.4 | 391.3 | 395.3 | 399.4 |
| ΣTiO₂ layer thicknesses | 37.4 | 57.5 | 37.4 | 36.1 | 34.3 |
| ΣSiO₂ layer thicknesses | 344.5 | 335.9 | 342.9 | 348.1 | 354.2 |
| ΣSiO₂ layer thickness | 139.5 | 139.5 | 137.9 | 139.1 | 143.8 |
| w/o 1. SiO₂ | | | | | |
| Ratio ΣTiO₂/ΣSiO2 | 0.27 | 0.41 | 0.27 | 0.26 | 0.24 |
| w/o 1. SiO₂ | | | | | |
| Ratio ΣTiO₂/ΣSiO₂ | 0.11 | 0.17 | 0.11 | 0.10 | 0.10 |

TABLE 6
Spectacle lens according to example, all values in nm

| Layer | example 16 | example 17 |
|---|---|---|
| ZrO₂ | 3.0 | 3.0 |
| SiO₂ | 210.9 | 207.6 |
| TiO₂ | 12.0 | 11.0 |
| SiO₂ | 41.0 | 38.5 |
| TiO₂ | 8.3 | 9.7 |
| SiO₂ | 12.8 | 15.1 |
| ITO | 3.0 | 3.0 |
| TiO₂ | 13.2 | 11.9 |
| SiO₂ | 90.3 | 86.5 |
| Clean coating | 5.0 | 5.0 |
| Layer stack thickness | 399.5 | 391.3 |
| ΣTiO₂ layer thicknesses | 33.5 | 32.6 |
| ΣSiO₂ layer thicknesses | 355.0 | 347.7 |
| ΣSiO₂ layer thickness | 144.1 | 140.1 |
| w/o 1. SiO₂ | | |
| Ratio ΣTiO₂/ΣSiO2 | 0.23 | 0.23 |
| w/o 1. SiO₂ | | |
| Ratio ΣTiO₂/ΣSiO₂ | 0.09 | 0.09 |

### II Method of Manufacturing the Spectacle Lenses

### Examples 1 to 3, 6, 8, 9, 12, 14 and Comparative Examples 1 to 4

The layer sequence of examples 1 to 3, 6, 8, 9, 12, 14 and of comparative examples 1 to 4 was deposited on respective spectacle lens coated with a polysiloxane hard coating by electron beam evaporation in a Bühler Leybold Optics Syrus 1100 vacuum coater (Bühler Leybold Optics, Alzenau, Germany) equipped with an Mark2+ ion source (Veeco, Plainview, US). The layer sequence of the spectacle lenses according to the examples and comparative examples are described before with respect to Tables 2 to 6.

The layer materials SiO₂, ZrO₂, ITO (indium tin oxide) and TiO₂ have been placed in different crucible positions of the electron beam evaporator of the vacuum coater.

The layer sequence was entered into the control software of the vacuum coater.

Then the spectacle lens was placed in the substrate holder of the vacuum coater and the chamber was evacuated down to a pressure of 2·10⁻⁵ mbar. In a first step the surface of the spectacle lens was treated in the vacuum chamber with an ion pre-treat process (IPC). The ion source available in the vacuum chamber was switched on. As a result Ar⁺ Ions with an energy of approximately 120 eV with an ion current density of 80 μA/cm² reach the surface of the spectacle lens. This ion treatment was done for 60 s. Then the ion source was switched off and the deposition of the layer sequence began.

The layers of the layer stack have been deposited in the sequence and with thicknesses as indicated in the Tables 2 to 6 using the following deposition rates: ZrO₂: 0.35 nm/s, SiO₂: 1.0 nm/s, TiO₂: 0.3 nm/s and ITO: 0.15 nm/s. The ion source was switched on during the deposition of TiO₂ and with O₂ gas. The ion source was also switched on during the deposition of the ITO layer operating with Ar gas and additional reactive gas O₂ in the chamber. The respective ion current densities are around 40 μA/cm² at the surface of the spectacle lenses.

After the completion of the deposition of the layer stack the chamber was vented to reach atmospheric pressure.

The spectacle lenses had a spherical power of −2D.

### III Characterization of the Spectacle Lenses

### IIIa Visual Assessment

The spectacle lenses according to the examples and comparative examples have been inspected visually under an illumination that is close to standard D65 illuminant (Osram Dulux L 36W/954, Osram GmbH, Germany) for detecting the greenish shimmer by an inspection person. In a first step, the spectacle lenses had been looked on from top to check the color impression close to 0° angle of incidence. In a second step, the spectacle lenses had been tilted and looked at under oblique angle of incidence. The appearance of greenish shimmer was rated by visual perception of the inspection person to be acceptable or not. The visual inspection of all spectacle lenses according to the examples were rated to show no greenish shimmer under oblique incidence.

### IIIb Spectral Reflectance and Residual Reflectance Color at Angle of Incidence of 0°

The spectral reflectance in the wavelength interval between 250 nm and 1000 nm of the spectacle lenses according to example 1, was measured at an angle of incidence of 0° using the instrument F10-AR, Filmetrics, USA. The spectral reflectance of the respective layer stack was also calculated and compared to the measured spectral reflectance using the software OptiRE (OptiRe 64 for Windows, Version 14.57, OptiLayer GmbH, Germany). The difference between the calculated and measured spectrum was rated via the discrepancy function D offered by the software. A value of D<5 was rated as satisfactory agreement between measurement and calculated spectral reflectance.

From the data of the spectral reflectance the CIELAB light L* and the CIELAB a*,b* coordinates have been calculated using the software OptiRE (OptiRe 64 for Windows, Version 14.57, OptiLayer GmbH, Germany). For the calculation the illuminant D65 and the 10° observer have been selected from the calculation options offered by the software. The CIELAB a*,b* coordinates of example 1 calculated from the measured spectral reflectance have been compared with the target range for the residual reflectance color in the before described rectangular region in the a*,b* plane. It was found that the CIELAB a*,b* coordinates lie well within the target range. Summing up, example 1 fulfils the requirements for the residual reflectance color and does not show greenish shimmer in the visual inspection under oblique angles of incidence.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A spectacle lens comprising an anti-reflective coating, the anti-reflective reflective coating as defined in ISO 13666:2019(E), entry 3.18.3, the anti-reflective coating containing a layer stack, the spectacle lens having, in an interval of angles of incidence, a residual reflectance color in CIE 1976 L*a*b* color space,
wherein
at an angle of incidence of 0°, positions of CIELAB a*,b* coordinates for the residual reflectance color lie in a rectangular region in an a*,b* plane, the rectangular region in the a*,b* plane being defined by 2≤a*≤9.2 and 7≤b*≤16.8,
in an interval of angles of incidence limited by an angle of incidence of >0° and an angle of incidence of 75°, each position of CIELAB a*, b* coordinates for the residual reflectance color, in the a*,b* plane, has a value D≥0, with D=b*+6.5·a*+6.5,
the CIELAB a*,b* coordinates are determined with respect to a single surface of the spectacle lens comprising the anti-reflective coating.

2. The spectacle lens according to claim 1, wherein in the interval of angles of incidence limited by the angle of incidence of >0° and the angle of incidence of 75°, each position of CIELAB a*,b* coordinates for the residual reflectance color, in the a*,b* plane, has a value D₁≤0, with D₁=b*+6.9·a*−80.

3. The spectacle lens according to claim 1, wherein in the interval of angles of incidence limited by the angle of incidence of >0° and the angle of incidence of 75°, a position of CIELAB a*,b* coordinates for the residual reflectance color, in the a*,b* plane, has a value D₂≥0, with D₂=b*+5.5·a*+13.75 and/or a position of CIELAB a*,b* coordinates for the residual reflectance color lie in the rectangular region in the a*,b* plane.

4. The spectacle lens according to claim 1, wherein in the layer stack a ratio of a sum over layer thicknesses of layers each having a refractive index n>2.1 at 500 nm to a sum over layer thicknesses of layers each having a refractive index n<1.6 at 500 nm is in a range selected from:
a ratio of from 0.05 to 0.35,
a ratio of from 0.07 to 0.28,
a ratio of from 0.09 to 0.20,
a ratio of from 0.10 to 0.18.

5. The spectacle lens according to claim 1, wherein in the layer stack a layer thickness of at least one layer having a refractive index n of 1.8≤n≤2.2 at 500 nm equals a layer thickness of at least one layer comprising a transparent conductive oxide.

6. A data set comprising at least one kind of the following kinds of data:
i) data of the spectacle lens according to claim 1, the data of the spectacle lens being configured for the purpose of a use for a manufacture of the spectacle lens according to claim 1,
ii) data containing computer-readable instructions for controlling one manufacturing machine or more manufacturing machines to manufacture the spectacle lens according to claim 1.

7. A method configured for calculating, by a computer, data of a spectacle lens, the data of the spectacle lens including data of an anti-reflective coating, the data of the anti-reflective coating including data of a layer stack, the data of the spectacle lens including the data of the anti-reflective coating being configured for the purpose of a use for a manufacture of the spectacle lens comprising the anti-reflective coating, the method comprising the step of:
determining in the data of the layer stack a layer thickness of each layer of the layer stack such that a calculation of a residual reflectance color in CIE 1976 L*a*b* for the data of the spectacle lens comprising the data of the layer stack meets a predefined residual reflectance color in CIE 1976 L*a*b* color space at predefined angles of incidence, wherein
at a predefined angle of incidence of 0°, positions of CIELAB a*,b* coordinates for the predefined residual reflectance color lie in a rectangular region in an a*,b* plane, the rectangular region in the a*,b* plane being defined by 2≤a*≤9.2 and 7≤b*≤16.8,
at each predefined angle of incidence lying in an interval of angles of incidence limited by a predefined angle of incidence of greater than 0° and a predefined angle of incidence of 75°, each position of CIELAB a*, b* coordinates for the predefined residual reflectance color, in the a*,b* plane, has a value D≥0, with D=b*+6.5·a*+6.5.

8. The method according to claim 7, wherein the data of the anti-reflective coating is in form of an output file and the output file is configured for a data processing system operating a manufacturing unit for coating a surface of the spectacle lens.

9. The method according to claim 7, wherein at each predefined angle of incidence lying in the interval of angles of incidence limited by the predefined angle of incidence of >0° and the predefined angle of incidence of 75°, each position of CIELAB a*,b* coordinates for the predefined residual reflectance color, in the a*,b* plane, has a value D₁≤0, with D₁=b*+6.9·a*−80.

10. The method according to claim 7, wherein at each predefined angle of incidence lying in the interval of angles of incidence limited by the predefined angle of incidence of >0° and the predefined angle of incidence of 75°, a position of CIELAB a*,b* coordinates for the predefined residual reflectance color, in the a*,b* plane, has a value D₂≥0, with D₂=b*+5.5·a*+13.75 and/or a position of CIELAB a*,b* coordinates for the predefined residual reflectance color lie in the rectangular region in the a*,b* plane.

11. The method according to claim 7, further comprising the step of:
determining the layer stack such that a ratio of a sum over layer thicknesses of layers each having a refractive index n>2.1 at 500 nm to a sum over layer thicknesses of layers each having a refractive index n<1.6 at 500 nm is in a range selected from:
a ratio of from 0.05 to 0.35,
a ratio of from 0.07 to 0.28,
a ratio of from 0.09 to 0.20,
a ratio of from 0.10 to 0.18.

12. The method according to claim 7, further comprising the step of:
determining the layer stack such that a layer thickness of at least one layer having a refractive index n of 1.8≤n≤2.2 at 500 nm equals a layer thickness of at least one layer comprising a transparent conductive oxide.

13. The method according to claim 7, the method further comprising the step of manufacturing the spectacle lens comprising the anti-reflective coating based on the data of the spectacle lens comprising the data of the anti-reflective coating.

14. A computer program comprising instructions which, when the program is executed by a computer, cause the computer to carry out the method according to claim 7.

15. A computer configured to perform the method according to claim 7.
